(19) United States
(12) Patent Application Publication
(10) Pub. No.: US 2026/0208368 A1
(43) Pub. Date: Jul. 23, 2026

(54) GRAPHENE INFUSED PIEZORESISTIVE VISION BASED TACTILE SENSOR

(71) Applicant: Khalifa University of Science and Technology, Abu Dhabi (AE)

(72) Inventors: Abdulla Solayman, Abu Dhabi (AE); Yarjan Abdul Samad, Abu Dhabi (AE); Hussain Sajwani, Abu Dhabi (AE); Laith Abu Assi, Abu Dhabi (AE); Abdulla Ayyad, Abu Dhabi (AE); Yahya Zweiri, Abu Dhabi (AE)

(21) Appl. No.: 19/029,987

(22) Filed: Jan. 17, 2025

(51) Int. Cl. B25J 13/08

(52) U.S. Cl. CPC B25J 13/082; B25J 13/084; B25J 13/088

(57) ABSTRACT

A multifunctional sensor for simultaneously detecting a change in force on a surface and a position change of a robotics device. The multifunctional sensor can include a piezoresistive textile and a vision system. The piezoresistive textile and the vision system can be electrically coupled to a data acquisition system for detecting a first output signal from the piezoresistive textile and a second output signal from the camera and determining from the first output signal and the second output signal a change in force and a change in location of the robotics device.

### BACKGROUND OF THE INVENTION

Slippage detection, contact force estimation, and grasp control are key features for robotic grippers where tactile sensing remains a key element that enables gripping devices to achieve robust grasping and successful object manipulation. Several types of tactile sensors and methods have been addressed and integrated with robotic applications to avail such features. For example, one class of tactile devices, vision-based tactile sensors are used to detect deformations. However, the method often includes obtaining a three-dimensional deformation field through stereophotometrey, binocular camera setups, mirrors, or machine learning. These measurements can be performed using nonlinear mathematical modeling and often fail at capturing the materials full range of behavior. The increased expectation of robots to complete tasks that require high precision while maintaining fast and reliable response are of upmost interest. At present, 2D materials present a highly reliable option for light, highly conductive materials.

### BRIEF SUMMARY OF THE INVENTION

The Summary is provided to introduce a selection of concepts that are further described below in the Detailed Description. This Summary is not intended to identify key or essential features of the claimed subject matter, nor is it intended to be used as an aid in limiting the scope of the claimed subject matter.

Embodiments of the present disclosure include a multifunctional sensor that includes a piezoresistive textile and a vision system positioned in a space above the piezoresistive textile. The piezoresistive textile may be configured to physically contact a surface. The vision system, of the vision based tactile sensor, may be configured to read a back side of the piezoresistive textile. The multifunctional sensor may simultaneously detect both a pressure and a position of the robotic device. The multifunctional sensor includes a data acquisition system electrically coupled to the piezoresistive textile and electrically coupled to the vision system. The data sensor system may be configured to detect a first output signal from the piezoresistive textile and a second output signal from the vision system. The first output signal corresponds to a force difference. The second output signal corresponds to a position change in the multifunctional sensor.

Another embodiment is directed to a method for using the multifunctional sensor to monitor force and position of a robotic device. The method can include providing a multifunctional sensor comprising a piezoresistive textile and a vision system. The piezoresistive textile may be configured to physically contact a surface. The vision system is positioned in a space above the piezoresistive textile and configured to read a back side of the piezoresistive textile. The method can also include measuring, by a data acquisition system electrically coupled with the piezoresistive textile, a first output signal corresponding to a change in surface contact. The method can also include measuring, by the data acquisition system electrically coupled with the piezoresistive textile and the vision system, a second output signal corresponding to a change in position of the piezoresistive textile.

These illustrative examples are mentioned not to limit or define the disclosure, but to provide examples to aid understanding thereof. Additional embodiments and examples are discussed in the Detailed Description, and further description is provided there.

### BRIEF DESCRIPTION OF THE DRAWINGS

The present application includes the following figures. The figures are intended to illustrate certain embodiments and/or features of the compositions and methods, and to supplement any description(s) of the compositions and methods. The figures do not limit the scope of the compositions and methods, unless the written description expressly indicates that such is the case.

FIG. 1 shows a vertically oriented multifunctional sensor schematic, according to some embodiments of the present disclosure.

FIG. 2A shows a piezoresistive textile positioned between two layers of elastomers for use in the multifunctional sensor, according to some embodiments of the present disclosure.

FIG. 2B shows a piezoresistive textile positioned between two layers of elastomers, having a round shape, for use in the multifunctional sensor, according to some embodiments of the present disclosure.

FIG. 2C shows a piezoresistive textile positioned between two layers of elastomers, having a square shape, for use in the multifunctional sensor, according to some embodiments of the present disclosure.

FIG. 2D shows a piezoresistive textile positioned between two layers of elastomers, having a square shape, for use in the multifunctional sensor, according to some embodiments of the present disclosure.

FIG. 3 shows a graph of the piezoresistive textile response, in the multifunctional sensor, over 10,000 cycles in a 22 hour duration and under 8N of force, according to some embodiments of the present disclosure.

FIG. 4 depicts a vertical orientation of a multifunctional sensor performing a slip detection test and a graph representing the change in force at each of the three stages of the slip test, according to some embodiments of the present disclosure.

FIG. 5 shows a flow chart of an example method for monitoring slips and detecting force changes using a multifunctional sensor, according to some embodiments of the present disclosure.

FIG. 6 is a block diagram of a controller for a multifunctional sensor system according to certain aspects of the present disclosure.

### DETAILED DESCRIPTION OF THE INVENTION

In the following description, various embodiments will be described. For purposes of explanation, specific configurations and details are set forth in order to provide a thorough understanding of the embodiments. However, it will also be apparent to one skilled in the art that the embodiments may be practiced in other configurations, or without the specific details. Furthermore, well-known features may be omitted or simplified in order not to obscure the embodiment being described.

Unlike conventional sensors where the signal only relies on a single input, multifunctional sensors as described herein introduce a graphene textile-based piezoresistive sensor integrated into an elastomer-fabricated Vision-Based Tactile Sensor (VBTS). Configurations incorporating both the piezoresistive sensor and the VBTS may be directed towards more diverse applications, including force and pose estimations in robotics. Notably, this sensor may provide feedback through deep learning neural networks. Feedback through the neural network may utilize marker tracking through a vision system, of the VBTS, to measure the angle and simultaneously utilize the piezoresistive sensor to measure the force. Thus, a novel sensor that serves multiple purposes, enhances tactile sensing capability and offers a modular approach to handle a wide category of objects/targets is an attractive option in robotic grippers. Similarly, such novel configurations improve the sensitivity and reaction times of the robotics device providing a novel slippage detection, contact force estimation and grasp control in robotics gripping devices.

Vision-based tactile sensors are a unit-compatible technique in humanized robots with only a camera as the active component. Such sensors are typically fabricated from an elastomeric material that will deform according to an applied force. When deforming, a camera perceiving the changed surface can detect the shape or the area of the deformation, hence crafting a feedback signal that will initiate a prompt command accordingly. This mode of operation gives VBTS a very high-resolution output, which can precisely tell the direction and distribution of contact forces. VBTS offers high-resolution input without accruing instrumentation costs compared to other forms of tactile devices.

However, using VBTS, translating the camera output into useful tactile measurements often requires obtaining the three-dimensional deformation field through stereophotometery, binocular camera setups, mirrors, or machine learning. Force measurements require converting the 3D deformation into force. This can be done using nonlinear mathematical modeling of elastomeric material, finite element modeling, and machine learning. Mathematical modeling can often fail at capturing the material's full range of behavior, and machine learning requires data with accurate ground-truth measurements. Therefore, while VBTS can precisely measure the direction and distribution of forces, getting the magnitude of the force requires extensive data collection, modeling, and calibration.

The interest in two-dimensional (2D) materials opened new horizons for scientific exploration as these materials carry unique characteristics. Integrating such advanced materials in the realm of sensors has ushered in a new era of sensing capabilities, benefiting from their exceptional properties, such as low force detection ranges, high stretchability, and superconductivity. Such sensors may be utilized in different applications including biosensors for glucose detection, gas sensing, or environment monitoring. Sensors that use resistivity as feedback signals in response to outside stimuli, usually pressure, are piezoresistive sensors. Piezoresistive sensors may offer alternative methods of obtaining force measurements. Additionally, piezoresistive sensors can be manipulated to change their limit of detection by using metals or other conductive compounds to alter the electrical response across the piezoresistive sensor.

Combining the two tactile modalities, piezoresistive and vision-based tactile sensing, the multifunctional sensor can output highly sensitive force measurements and give high-resolution spatial information regarding the direction of the force thereby allowing the robotic device, such as a gripper, to respond to the force. This novel sensor configuration provides highly sensitive and robust force measurements at high spatial resolution.

In some embodiments, the multifunctional sensor may include a piezoresistive textile configured to physically contact a surface and a vision system positioned in the space above the piezoresistive textile and configured to read a back side of the piezoresistive textile. The piezoresistive textile may be configured to perform as a piezoresistive sensor. In some embodiments, the multifunctional sensor simultaneously detects both a pressure and a position of the robotics device. For example, the multifunctional sensor may be integrated into an end of a robotic gripping device, such as to act like a fingertip.

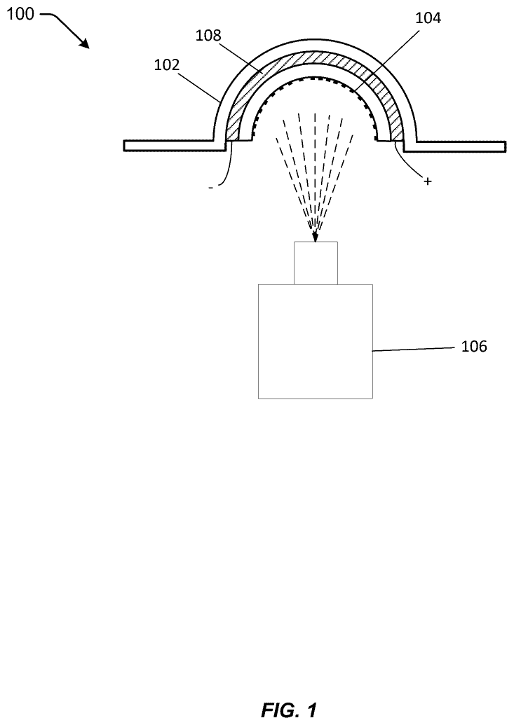

Turning now to the figures, FIG. 1 shows a vertically oriented multifunctional sensor schematic, according to embodiments of the present disclosure. In other examples, the multifunctional sensor 100 can include other orientations, for example horizontally. In a horizontal configuration, the multifunctional sensor robotics device may be oriented such that the robotics device can measure forces along a vertical direction (e.g., picking up or moving objects whereby the robotics device can “grip” an object).

In some embodiments, the multifunctional sensor 100 can include a piezoresistive textile 108 and a vision system 106. The piezoresistive textile 108 and the vision system 106 may be electrically coupled to a data acquisition system, the data acquisition system being configured to detect a first output signal and a second output signal. The first output signal may correspond to a force difference and the second output signal may correspond to a position change in the force applied to the multifunctional sensor.

In some embodiments, the vision system may be a camera,. In some embodiments, the vision system may be a high-speed vision system, such as a high-speed camera. In some embodiments, the vision system may be at least one camera, such as at least one high speed camera. The vision system 106 may be positioned in a space above the piezoresistive textile 108. For example, the multifunctional sensor 100 may be in a linear configuration such that the piezoresistive sensor is positioned at the tip of an robotics device. The space above the piezoresistive sensor may be in reference to the positioning of the vision system 106 in an empty space in-line with the piezoresistive sensor. The vision system 106 may not be in physical contact with the piezoresistive sensor. For example, the vision system 106 may be from about 1 mm to about 1 inch away from the piezoresistive sensor. The vision system 106 may be mounted to an arm and further oriented to capture high-speed images of the back side of the piezoresistive sensor. In some embodiments, the multifunctional sensor, as described herein, may be positioned on an external end of a robotics arm.

Included on the back side of the piezoresistive sensor (produced from the piezoresistive textile 108 and the elastomers 102) may be a series of markers 104. The markers 104 may be in physical contact, adhered to, or implanted on, the back side of the third layer of the elastomer composition. The number of markers 104 may be varied depending on the size and orientation of the piezoresistive textile 108. For example, the number of markers 104 may be from 5 to 169 equally spaced along the back side of the third layer of the elastomer composition. In some embodiments, the plurality of markers 104 may be about 169 markers. The vision system 106 may take high-speed images of the markers to determine the movement of the markers as a change in force is applied to the sensor.

As previously disclosed, the deformation may be detected by the vision system 106 via images taken translating the change of the marker position to a feedback signal for determining the change in location of the force. For example, as the robotic device grips an object, the markers 104 may detect if the object being gripped is slipping from the grasp. As the material slips from the robotics device, the location of the force applied to the sensor changes, thereby altering the positioning of the marker 104. Similarly, as the robotic arm manipulates the object being held, the force distribution or the position of the force on the piezoresistive sensor may change. The change in positioning may output a signal to the data acquisition system to generate a feedback loop. The feedback loop may provide an input signal to the robotic gripping device to change the position or orientation of the robotic device thereby altering the position of the object.

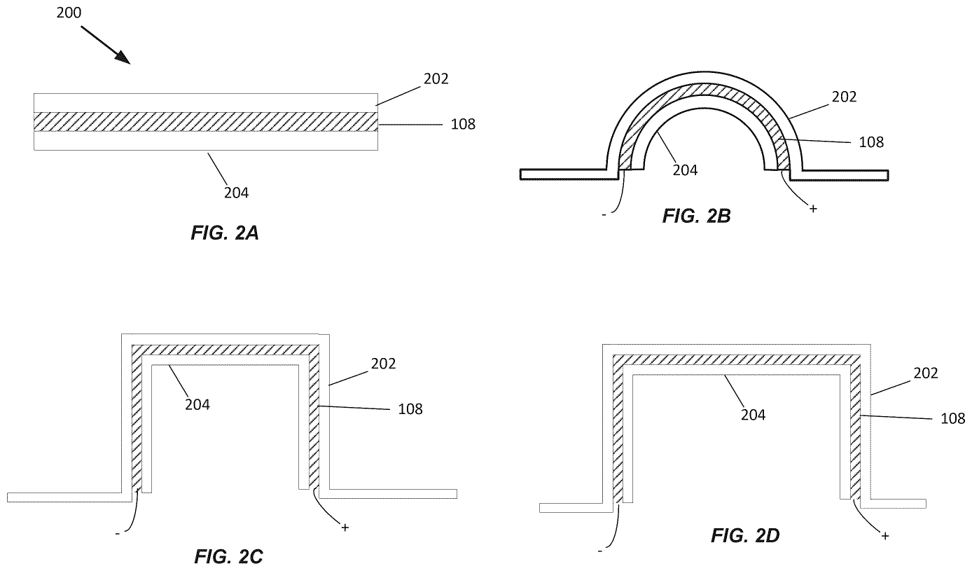

In some embodiments, piezoresistive textile 108 may be used to produce a piezoresistive sensor platform 200. The piezoresistive platform, of the multifunctional sensor, may include a 3 layered material. FIGS. 2A-2D depicts example piezoresistive textiles 108 positioned between two layers of elastomers for use in the multifunctional sensor, according to some embodiments of the present disclosure. The first layer 202 of elastomer may be positioned on a bottom surface. For example, the bottom surface may be the surface of the piezoresistive textile sensor that comes in physical contact with the objects and materials to be manipulated by the robotics gripper. The second layer may be made from the piezoresistive textile 108. The piezoresistive textile 108 may be electrically couped to a data acquisition system for measuring the change in electrical signal (e.g., via force applied to the surface of the tactile device).

In some embodiments, the piezoresistive textile 108 may be coated with an electrically conductive material. For example, the piezoresistive textile may be coated, or loaded, with graphene. One skilled in the art may understand that other suitable electrically conductive materials may be used to replace the graphene depending on desired use, or manipulation of the conductivity of the sensor. In some embodiments, the piezoresistive textile 108 may be loaded with from about 0.5 grams to 5 grams of graphene (e.g., 0.5 g to 4.5 g, 0.5 g to 4.0 g, 0.5 g to 3.5 g, 0.5 g to 3.0 g, or 0.5 g to 2.5 g of graphene). The graphene loaded textile exhibits unique responsiveness to external stimuli. For example, the graphene may increase the limit of detection of the multifunctional sensor 100. In some embodiments, the piezoresistive textile may be a graphene coated material, copper metal, or any other conductive refractory material.

In some embodiments, the piezoresistive textile 108 sensor may include a third layer 204, positioned on a top surface of the second layer. The third layer 204 may be an elastomer. In some embodiments, the first layer 202 and the third layer 204 may be the same elastomer. For example, the elastomer may be a silicone, a thermoplastic elastomer, or a combination thereof. The piezoresistive sensor may be fabricated having the same thickness across each layer of the piezoresistive sensor. In some embodiments, the first layer, the second layer, and the third layer may be from 1 mm to 500 mm thick. The thickness of the elastomer on the first layer 202 and the third layer 204 may be varied for a variety of applications. One skilled in the art may understand that the thickness of the elastomer on the first layer and the second layer may be thinner for a low force application whereas in an industrial setting or applications that might include a higher force, the thickness may be increased. In some embodiments, the sensors described herein may be used in robotics gripping devices for detection of slippage detection, contact force estimation, and grasp control.

Additionally, the piezoresistive textile 108 in the piezoresistive sensor platform 200 may be produced in various shapes and configurations. The shape or configuration may be application dependent. For example, the piezoresistive sensor platform 200 may have a round shape (FIG. 2B), a square shape (FIG. 2C), or a rectangle shape (FIG. 2D). Other shape configurations may be appropriate for the robotics device described herein. For example, other non-limiting examples can include an oval shape, an octagon shape, trapezoid shape, or a pyramid shape.

In some embodiments, the piezoresistive sensor platform 200, of the multifunctional sensor described herein, may be manufactured according to common methods of producing a piezoresistive sensor, such as 3D additive manufacturing methods. Other methods of fabricating piezoresistive sensing devices maybe used. For example, screen-printing may be employed to imprint on the piezoresistive textile onto the surface of the elastomers before the piezoresistive textile 108 is sandwiched between the two elastomer layers.

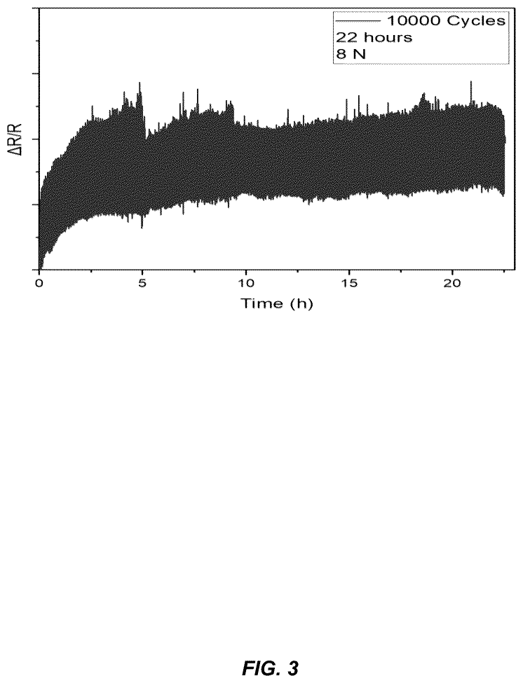

In some embodiments, the piezoresistive textile 108, loaded with graphene may achieve notable changes in output resistance during cycling. Changes in output resistance may be observed in FIG. 3. FIG. 3 shows a graph of the piezoresistive textile response, in the multifunctional sensor, over 10,000 cycles in a 22 hour duration and under 8N of force, according to some embodiments of the present disclosure. In one non-limiting example, the piezoresistive textile is loaded with 1 g of graphene, it achieves a notable change in output resistance during cyclic testing over 10000 cycles for almost 30 hours of continues usage.

In some embodiments, the piezoresistive sensor platform 200 can sustain a force of up to about 10 N. For example, the piezoresistive sensor platform 200 can sustain a force of about 1 N, about 2 N, about 3 N, about 4 N, about 5 N, about 6 N, about 7 N, about 8 N, about 9 N, or about 10 N. In some embodiments, the piezoresistive sensor platform 200 can sustain a force of up to about 10 N (e.g., from 0 N to 10 N, from 1 N to 10 N, or from 5 N to 10 N). In some embodiments, the piezoresistive platform 200 may be capable of withstanding a higher force by increasing the thickness of the elastomeric material.

In some embodiments, the piezoresistive sensor platform 200 can sustain a strain of greater than 20% during the course of use without failure. For example, the piezoresistive sensor platform 200 can sustain a strain of greater than 21%, greater than 22%, greater than 23%, greater than 24%, greater than 25%, greater than 26%, greater than 27%, greater than 28%, greater than 29%, greater than 30%, greater than 31%, greater than 32%, greater than 33%, greater than 34%, greater than 35%, greater than 36%, greater than 37%, greater than 38%, greater than 39%, greater than 40%, greater than 41%, greater than 42%, greater than 43%, greater than 44%, greater than 45%, greater than 46%, greater than 47%, greater than 48%, greater than 49%, greater than 50%, greater than 51%, greater than 52%, greater than 53%, greater than 54%, or greater than 55%. In some embodiments, the multifunctional sensor platform can sustain a strain of greater than 60%, greater than 70%, greater than 80%, greater than 90%, or up to 100% strain across the elastomer matrix. In some embodiments, the piezoresistive sensor platform 200 can sustain a strain of greater than 20% during the course of use without failure. For example, the piezoresistive sensor platform 200 can sustain a strain of from 20% to 100%, of from 40% to 100%, of from 60% to 100%, or of from 80% to 100% strain across the elastomer matrix.

Similarly, the piezoresistive sensor platform 200 may be capable of achieving a limit of detection of about 0.01 N. For example, the piezoresistive sensor platform 200 may have a limit of detection of from 0.01 N to about 0.05 N (e.g., 0.01 N, 0.02 N, 0.03 N, 0.04 N, or 0.05 N). In some embodiments, the multifunctional sensor described herein, including the piezoresistive sensor platform, may have a limit of detection of less than 0.01 N. The limit of detection may be improved for the multifunctional sensor, due in part, by the incorporation of the vision based tactile sensor and the piezoresistive textile in combination.

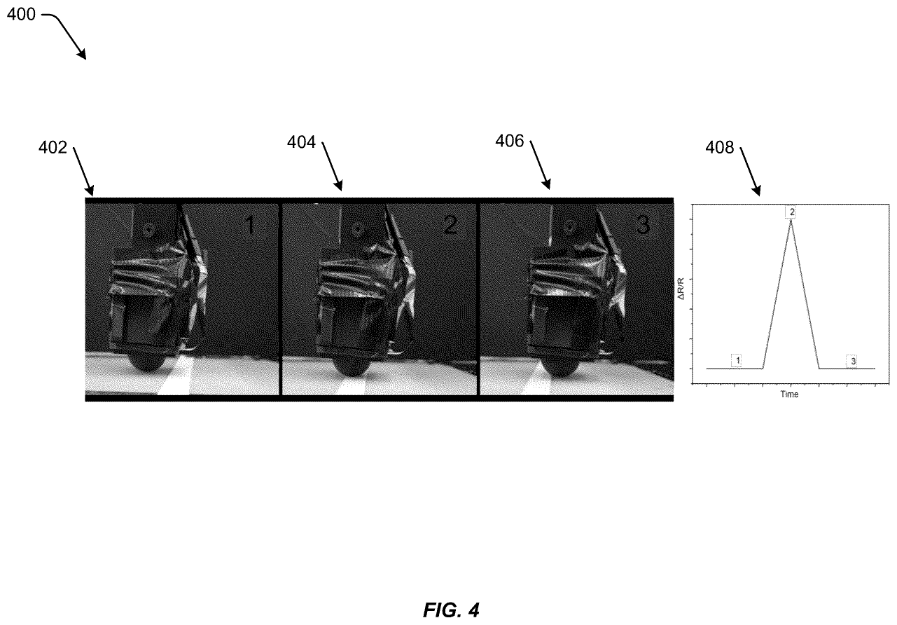

Turning now to FIG. 4, an example multifunctional sensor was produced and the sensitivity was assessed using the example device. The sensor was assembled and placed on a flat surface having a strip of scotch tape placed in its path. The sensor was placed on one side of the scotch tape 402 and passed over the top of the scotch tape 404 to the other side of the flat surface 406. As the multifunctional sensor passes across the scotch tape, a spike in current is observed in the electrical signal. The high sensitivity of the sensor can detect slipping at very low force, this is proven by the current spike 408 while the sensor moves across the very thin scotch tape. This result demonstrate the ability for the sensors described herein to detect small changes in force, allowing the robotics devices described herein to detect the smallest changes in force.

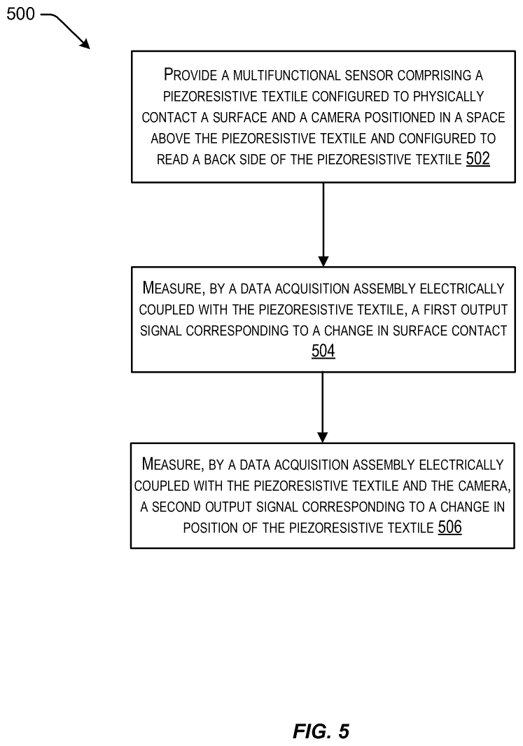

FIG. 5 shows a flow chart of an example method 500 for monitoring slips and detecting force changes using a multifunctional sensor, according to some embodiments of the present disclosure. In other examples, the method 500 can include more steps, fewer steps, different steps, or a different order of the steps depicted in FIG. 5.

At block 502, the method 500 can involve providing a multifunctional sensor comprising a piezoresistive textile configured to physically contact a surface and a vision system positioned in a space above the piezoresistive textile and configured to read a back side of the piezoresistive textile. In some embodiments, the piezoresistive textile of the multifunctional sensor may be produced via conventional 3D printing methods for producing multi-layered elastomer compositions. The piezoresistive textile may be loaded with an electrically conductive material, such as graphene, for generating an active layer, and producing an electrically reactive surface.

In some embodiments, the multifunctional sensor may include a plurality of markers imprinted on the back side of the piezoresistive textile. The plurality of markers may be used, by the vision system, to detect a position change of the force applied to the robotic device. The robotics device may be oriented in a vertical position whereby the robotics device comes down onto a surface. Similarly, the robotics device described herein may be oriented in a horizontal orientation for picking up and moving objects. In some embodiments, the multifunctional sensor described herein may be configured to a robotic device that may have a head configured to rotate about a central axis from 0 to 360 degrees.

At block 504, the method 500 can involve measuring, by the data acquisition system electrically coupled with the piezoresistive textile a first signal corresponding to a change in surface contact. For example, the change in surface contact may include a change in force applied to the piezoresistive textile. To detect the signal from the piezoresistive textile, the data acquisition system may detect a change in electrical resistance applied across the piezoresistive textile. For example, the piezoresistive textile, under mechanical strain or deformation due to an applied force, experiences a change in resistance that can be measured as an electrical signal proportional to the force applied to the piezoresistive textile.

At block 506, the method 500 can involve measuring, by the data acquisition system electrically coupled with the piezoresistive textile and the vision system, a second output signal corresponding to a change in position of the piezoresistive textile. For example, the change in force applied to the piezoresistive textile may move positions if the object is being dropped or if the robotics device is slipping. In such configurations, the vision system, using the markers imprinted on the back side of the piezoresistive textile, may capture images of the markers. As the markers move, in the images, the vison-based tactile device may interpret the move of the markers as a change in the force applied to the piezoresistive textile.

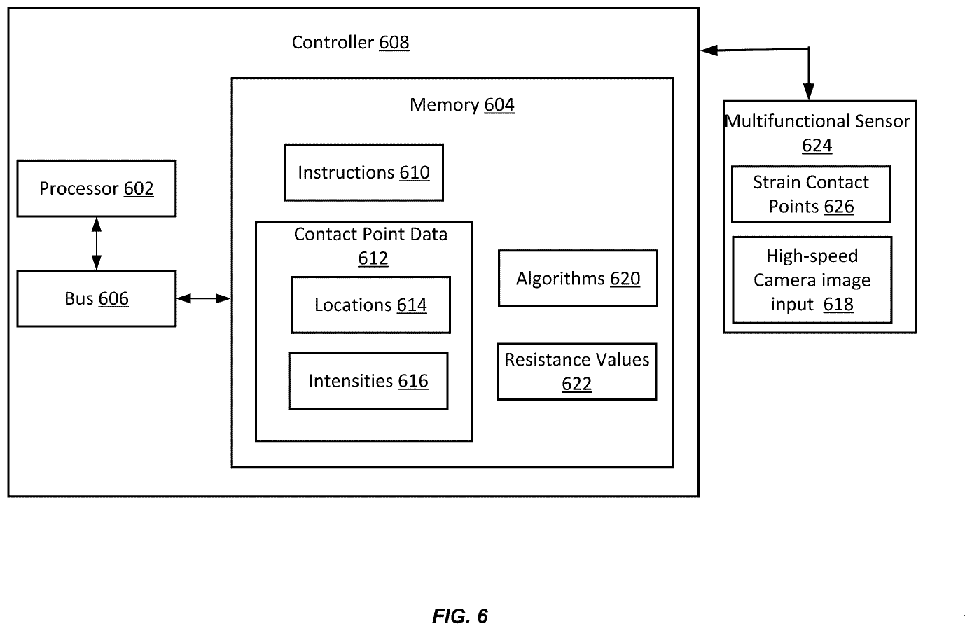

FIG. 6 is a block diagram of a controller 608 for a multifunctional sensor system according to certain aspects of the present disclosure. As referred to with respect to FIG. 6, the controller 608 maybe referred to, above, as the data acquisition system for receiving the first signal and the second signal of the multifunctional sensor system. Examples of the multifunctional sensor system can include multifunctional sensor system 100 from FIG. 1. As shown, the controller 608 includes a processor 602 communicatively coupled to memory 604. The processor 602 can include one processing device or multiple processing devices. Non-limiting examples of the processor 602 include a Field-Programmable Gate Array (FPGA), an application specific integrated circuit (ASIC), a microprocessor, or any combination of these. The processor 602 can execute instructions 610 stored in the memory 604 to perform operations. In some embodiments, the operations may be a response to a detection of slippage, pose, or force of the robotics device. In some examples, the instructions 610 can include processor-specific instructions generated by a compiler or an interpreter from code written in any suitable computer-programming language, such as C, C++, C#, Python, or Java.

The memory 604 can include one memory device or multiple memory devices. The memory 604 can be non-volatile and may include any type of memory device that retains stored information when powered off. Non-limiting examples of the memory 604 include electrically erasable and programmable read-only memory (EEPROM), flash memory, or any other type of non-volatile memory. At least some of the memory 604 can include a non-transitory computer-readable medium from which the processor 602 can read instructions 610. The non-transitory computer-readable medium can include electronic, optical, magnetic, or other storage devices capable of providing the processor 602 with the instructions 610 or other program code. Non-limiting examples of the non-transitory computer-readable medium include magnetic disk(s), memory chip(s), RAM, an ASIC, or any other medium from which a computer processor can read instructions 610.

The memory 604 can further include algorithms 620, vision systemimage input 618, resistance values 622, and contact point data 612. The contact point data 612 can include data associated with strain contact points 626 of the multifunctional sensor 624 including locations 614 and intensities 616. Examples of the algorithms 620 can include ANNs, perceptron neural networks, HMM neural networks, convolution neural networks, or any other neural networks or non-neural network algorithms that can receive input resistance data and vision system image input for locations and generate outputs. In some embodiments, the output may include an action such as a change in applied pressure of the robotics device or a change in motion action. The controller 608 can receive the vision system image inputs 618 and resistance values 622 from the multilayer sensor system 624. For example, the high-speed camera image inputs 618 can be associated with a change in the position, orientation, or angles of the integrated markers and the resistance values 622 can be associated with piezoresistive textile layer, portions of the piezoresistive textile layer, or across the entire surface of the piezoresistive textile layer of a multifunctional sensor. The controller 608 can use the high-speed camera image input 618 and the resistance values 622 to determine the locations 614 and intensities 616 of the strain contact points 626. In some examples, the controller 608 can use at least one of the algorithms 620 to determine the locations 614 and intensities 616.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art. Indeed, the methods and systems described herein may be embodied in a variety of other forms; furthermore, various omissions, substitutions, and changes in the form of the methods and systems described herein may be made without departing from the spirit of the present disclosure. The accompanying claims and their equivalents are intended to cover such forms or modifications as would fall within the scope and spirit of the present disclosure.

Unless otherwise defined, all terms of art, notations, and other scientific or medical terms or terminology used herein are intended to have the meanings commonly understood by those of ordinary skill in the art. In some cases, terms with commonly understood meanings are defined herein for clarity and/or for ready reference, and the inclusion of such definitions herein should not be construed as representing a substantial difference over the definition of the term as generally understood in the art.

Articles “a” and “an” are used herein to refer to one or to more than one (i.e., at least one) of the grammatical object of the article. By way of example, “an element” means at least one element and can include more than one element.

The use herein of the terms “including,” “comprising,” or “having,” and variations thereof, is meant to encompass the elements listed thereafter and equivalents thereof as well as additional elements. Embodiments recited as “including,” “comprising,” or “having” certain elements are also contemplated as “consisting essentially of and ”consisting of those certain elements. As used herein, “and/or” refers to and encompasses any and all possible combinations of one or more of the associated listed items, as well as the lack of combinations where interpreted in the alternative (“or”).

Recitation of ranges of values herein are merely intended to serve as a shorthand method of referring individually to each separate value falling within the range, unless otherwise indicated herein, and each separate value is incorporated into the specification as if it were individually recited herein. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this disclosure.

The terms “about” and “approximately” as used herein shall generally mean an acceptable degree of error for the quantity measured given the nature or precision of the measurements. Exemplary degrees of error are within 20% (%); preferably, within 10%; and more preferably, within 5% of a given value or range of values. Any reference to “about X” or “approximately X” specifically indicates at least the values X, 0.95X, 0.96X, 0.97X, 0.98X, 0.99X, 1.01X, 1.02X, 1.03X, 1.04X, and 1.05X. Thus, expressions “about X” or “approximately X” are intended to teach and provide written support for a claim limitation of, for example, “0.98X.” Numerical quantities given herein are approximate unless stated otherwise, meaning that the term “about” or “approximately” can be inferred when not expressly stated. When “about” is applied to the beginning of a numerical range, it applies to both ends of the range.

What is claimed is:

1. A multifunctional sensor comprising:
a piezoresistive textile configured to physically contact a surface;
a vision system positioned in a space above the piezoresistive textile and configured to read a back side of the piezoresistive textile, wherein the multifunctional sensor simultaneously detects both a pressure and a position a robotics device; and
a data acquisition system electrically coupled to the piezoresistive textile and electrically coupled to the vision system, the data sensor system being configured to detect a first output signal from the piezoresistive textile and a second output signal from the vision system, the first output signal corresponds to a force difference, the second output signal corresponds to a position change of the force being applied to the multifunctional sensor.

2. The multifunctional sensor of claim 1, wherein the vision system is at least one camera.

3. The multifunctional sensor of claim 1, wherein the piezoresistive textile further comprises:
a first layer of an elastomer positioned on a bottom surface;
a second layer, positioned on a top surface of the first layer, wherein the second layer is a coated textile; and
a third layer, positioned on a top surface of the second layer, wherein the third layer is an elastomer.

4. The multifunctional sensor of claim 2, wherein the first layer and the third layer are the same elastomer, wherein the elastomer is silicone or a thermoplastic elastomer.

5. The multifunctional sensor of claim 2, wherein the coated textile is a graphene coated textile.

6. The multifunctional sensor of claim 2, further comprising a plurality of markers positioned on a bottom surface of the third layer, wherein the markers are imprinted on an inner surface of the third layer.

7. The multifunctional sensor of claim 4, wherein the coated textile is loaded with from 0.5 to 3 g of graphene.

8. The multifunctional sensor of claim 1, wherein the piezoresistive textile is in a round shape, a square shape, or a rectangle shape.

9. The multifunctional sensor of claim 1, wherein the multifunctional sensor can sustain a force of from about 1 N to 10 N.

10. The multifunctional sensor of claim 1, wherein the multifunctional sensor has a limit of detection of up to 0.01 N, and wherein the multifunctional sensor sustains greater than 50% strain.

11. A method comprising:
providing a multifunctional sensor comprising:
a piezoresistive textile configured to physically contact a surface; and
a vision system positioned in a space above the piezoresistive textile and configured to read a back side of the piezoresistive textile;
measuring, by a data acquisition system electrically coupled with the piezoresistive textile, a first output signal corresponding to a change in surface contact;
measuring, by the data acquisition system electrically coupled with the piezoresistive textile and the vision system, a second output signal corresponding to a change in position of the piezoresistive textile.

12. The method of claim 11, wherein measuring the first output signal corresponding to a change is surface contact comprises:
detecting, by the data acquisition system electrically coupled to the piezoresistive textile, the first output signal from the piezoresistive textile, the first output signal corresponding to an electrical resistance transmitted through the piezoresistive textile caused by mechanical strain; and
determining the first output signal, wherein the first output signal is a force.

13. The method of claim 11, wherein measuring the second output signal 2 corresponds to a change in position of the piezoresistive textile comprises:
detecting, by the data acquisition system electrically coupled with the piezoresistive textile and the vision system, the second output signal from the vision system, the second output signal corresponding to a change in surface of the piezoresistive textile;
determining the second output signal, wherein the second output signal is a location.

14. The method of claim 11, wherein the piezoresistive textile further comprises:
a first layer of an elastomer positioned in on a bottom surface;
a second layer, positioned on a top surface of the first layer, wherein the second layer is a coated textile; and
a third layer, positioned on a top surface of the second layer, wherein the third layer is an elastomer.

15. The method of claim 14, wherein the piezoresistive textile further comprises a plurality or markers positioned on an first side of the third layer, wherein the first side of the third layer is positioned in-line with the vision system, wherein the vision system is at least one camera.

16. The method of claim 14, wherein the coated textile is a graphene coated textile.

17. The method of claim 16, wherein the coated textile is loaded with from 0.5 to 3 g of graphene.

18. The method of claim 11, wherein the method further comprises:
performing an action based on the first output signal and the second output signal, wherein the action performed causes a change in the first output signal and the second output signal.

19. The method of claim 11, wherein the multifunctional sensor has a limit of detection of up to 0.01 N.

20. A gripping device produced from the multifunctional sensor of claim 1.
